(19) United States
(12) Patent Application Publication
(10) Pub. No.: US 2002/0121955 A1
(43) Pub. Date: Sep. 5, 2002

(54) Low profile transformer

(76) Inventors: Ming Yeh, Banchiau City (TW); Heng Cheng Chou, Shinjuang City (TW); Chien-Chia Lin, Taoyuan City (TW)

Correspondence Address: BIRCH STEWART KOLASCH & BIRCH, PO BOX 747, FALLS CHURCH, VA, 22040-0747, US

(21) Appl. No.: 09/974,057

(22) Filed: Oct. 11, 2001

(30) Foreign Application Priority Data
Mar. 5, 2001 (TW) 90203179

(51) Int. Cl. H01F 27/30

(52) U.S. Cl. 336/198

(57) ABSTRACT

The present invention provides a low profile transformer including a bobbin and core structure. The bobbin further includes a primary coil, a secondary coil and a plurality of pins formed thereon. The core structure is coupled to the bobbin. In addition, the core structure includes an I-core and two U-cores coupled to each other. Alternatively, the I-core includes at least one recessed edge and the U-cores include at least one protrusive edge. The U-cores are coupled to the I-core by means of the recessed edge and the protrusive edge.

### BACKGROUND OF THE INVENTION

1. Field of the Invention

The present invention relates to a transformer, and more particularly to a low profile transformer.

2. Description of the Prior Art

As shown in FIG. 1(a), the conventional transformer 60 is composed of a bobbin 10 and a core structure 20. Among these, the bobbin 10 further includes the primary coil, the secondary coil and a plurality of pins 11 formed thereon. However, the distinction between the primary coil and the secondary coil is not clearly shown in FIG. 1(a) for purpose of simplicity.

In the conventional transformer, the core structure 20 shown in FIG. 1(a) or FIG. 1(b) includes an oblong core 30 and an I-core 50. Among these, each of the terminals of the oblong core 30 includes a recess 35 for accommodating the end of the I-core 50. Besides, the upper surface of the oblong core 30 and the upper surface of the I-core 50 are on the same level. As such, the combination of the oblong core 30 and the I-core 50 provides a closed magnetic circuit.

However, as shown in FIG. 1(b), in the effort to thin the core structure 20 (i.e. to thin both of the oblong core 30 and the I-core 50), the recess 35 makes the oblong core 30 easy be snapped into two and hard be fabricated. The recess 35 is formed on the lengthwise axis of the oblong core 30 such that the lower portion 37 under the recess 35 combines the right half and left half of the oblong core 30. If the oblong core 30 is thinned, the lower portion 37 under the recess 35 fails to support the oblong core 30. As a result, the oblong core 30 tends to easy be snapped into two.

Therefore, there is a need in the art for an improved transformer to solve the above-mentioned problem.

### SUMMARY OF THE INVENTION

The present invention reduces the thickness of the transformer by providing an improved core structure. That is, the present transformer has lower profile compared to prior art.

The present transformer includes a bobbin and a core structure. Among these, the bobbin further includes the primary coil, the secondary coil and a plurality of pins formed thereon.

In the first embodiment, the core structure further includes an I-core and two U-cores. Each of the U-cores is coupled to the respective lateral of the I-core.

In the second embodiment, the core structure further includes an I-core and two U-cores. The I-core includes at least one recessed edge, such as two recessed edges. The two recessed edges are formed on the respective terminal of the I-core. It is noteworthy that the two recessed edges are formed on the same surface. Alternatively, the I-core includes a plurality of recessed edges, such as four recessed edges. Besides, the four recessed edges are formed on the four corners and the same surface of the I-core.

The U-core further includes at least one protrusive edge. By means of the protrusive edge, each of the U-cores is coupled to laterals of the I-core.

In the third embodiment, the I-core includes at least one recessed edges. For example, there are four recessed edges formed on the respective corner of the I-core. In contrast with the second embodiment, the four recessed edges are formed on the different surface. Some recessed edges are formed on the upper surface and other recessed edges are formed on the lower surface.

The U-core further includes at least one protrusive edge. By means of the protrusive edge and the recessed edges, each of the U-cores is coupled to respective lateral of the I-core. It is noteworthy that in order to match the I-core, one U-core is placed upside down respective to other U-core.

During assembling, the I-core passes through the hollow body of the bobbin and the two U-cores are coupled to the laterals or terminals of the I-core. After that, the assembly of the present low profile transformer is completed.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1(a) depicts the conventional transformer

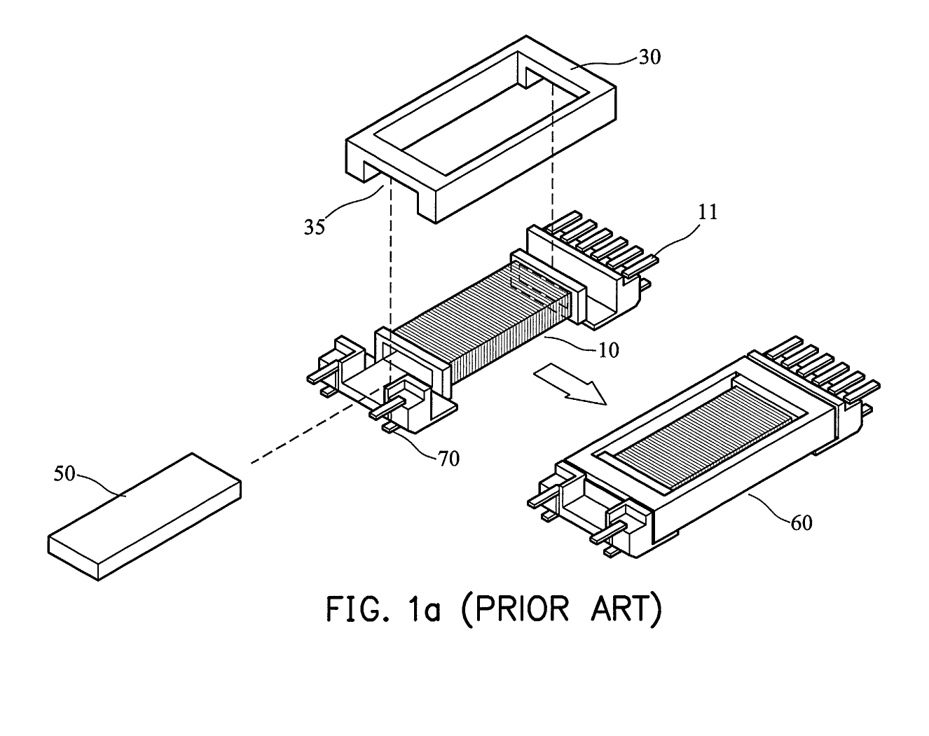

FIG. 1(b) depicts the core structure of the conventional transformer shown in FIG. 1(a)

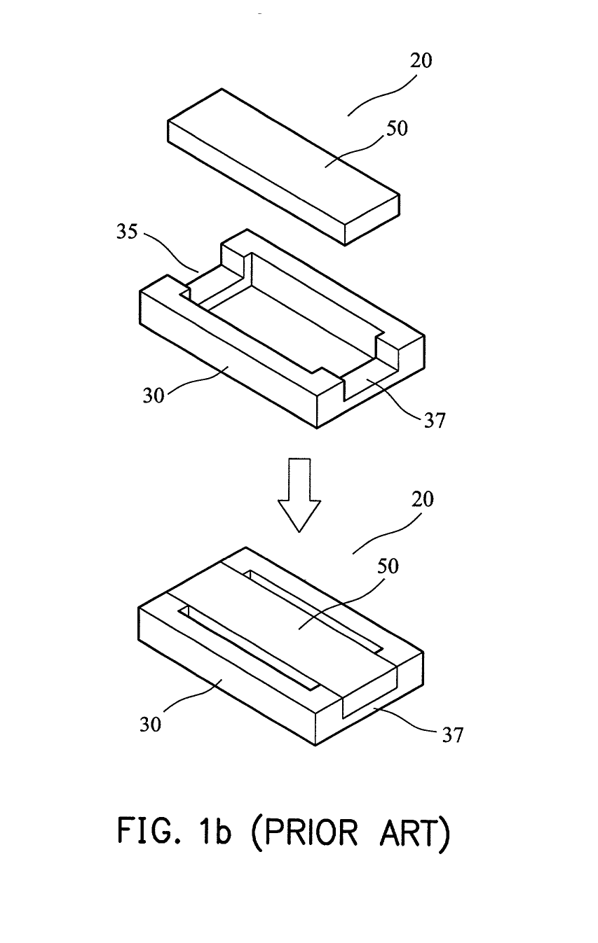

FIG. 2(a) depicts the core structure of the first embodiment according to the present invention

FIG. 2(b) depicts the core structure of the second embodiment according to the present invention;

FIG. 2(c) also depicts the core structure of the second embodiment according to the present invention;

FIG. 2(d) depicts the core structure of the third embodiment according to the present invention ; and

FIG. 3 depicts the present transformer according to the core structure shown in FIG. 2(b).

### DESCRIPTION OF THE PREFERRED EMBODIMENT

The present invention reduces the thickness of the transformer by providing an improved core structure. That is, the present transformer has lower profile compared to prior art.

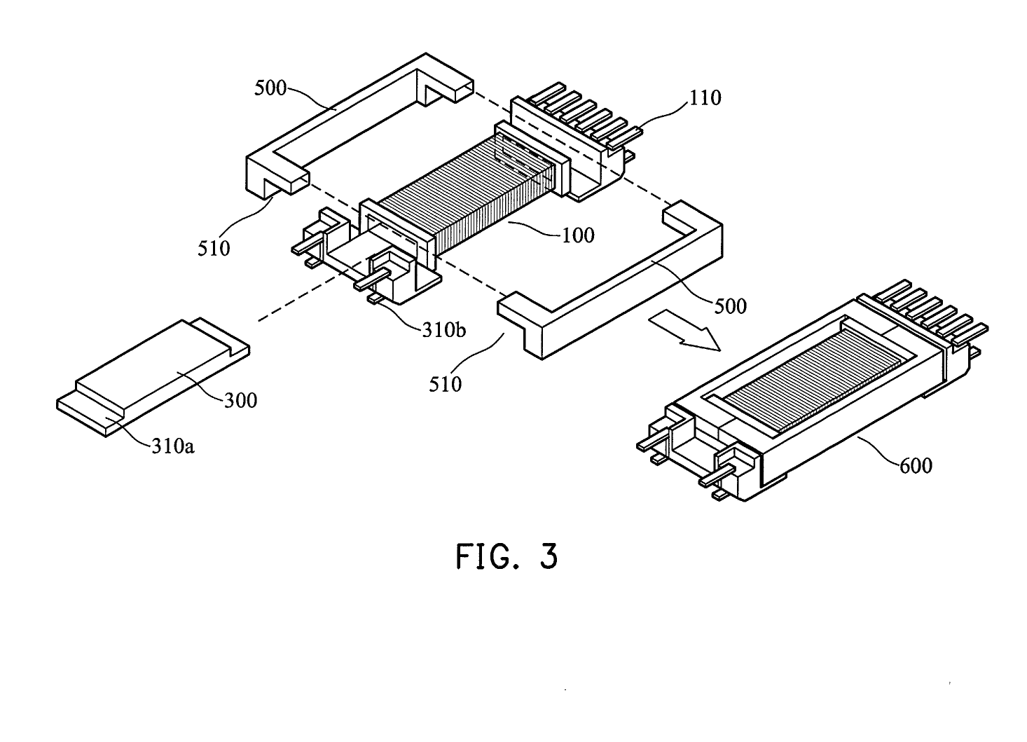

As shown in FIG. 3, the present transformer 600 includes a bobbin 100 and a core structure 200. Among these, the bobbin 100 further includes the primary coil, the secondary coil and a plurality of pins 110 formed thereon. However, the distinction between the primary coil and the secondary coil is not clearly shown in FIG. 3 for purpose of simplicity.

### The First Embodiment

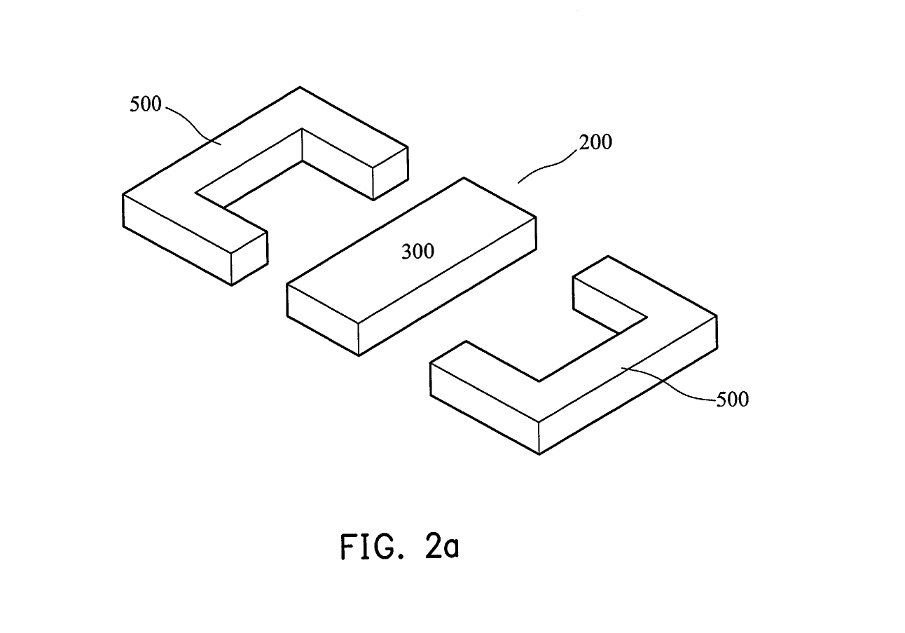

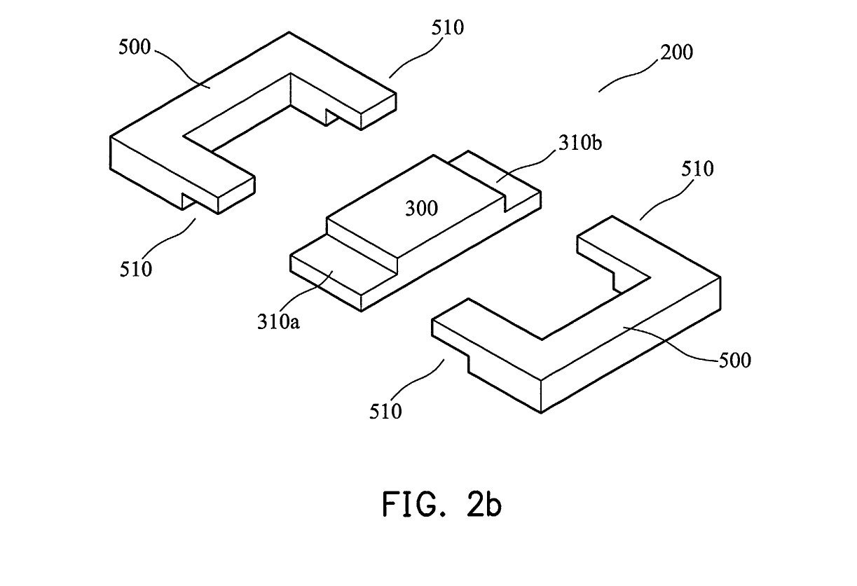

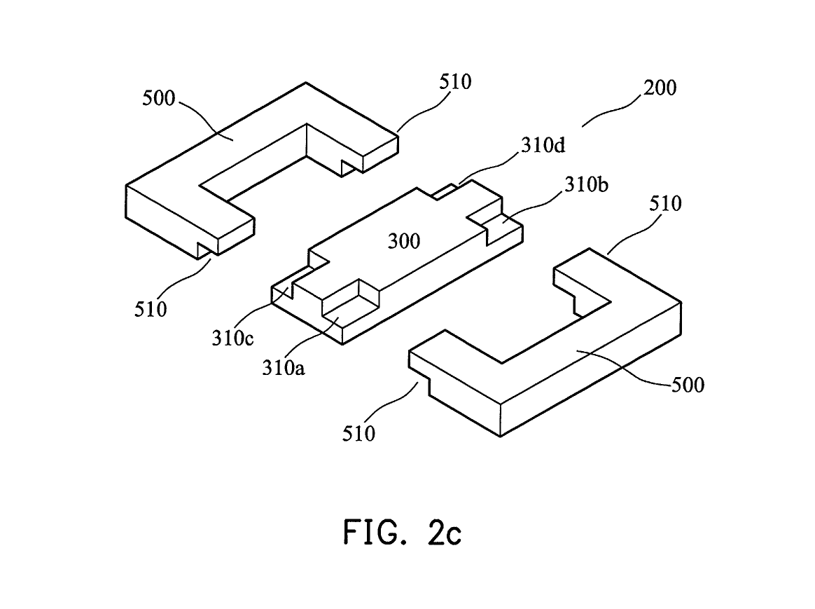

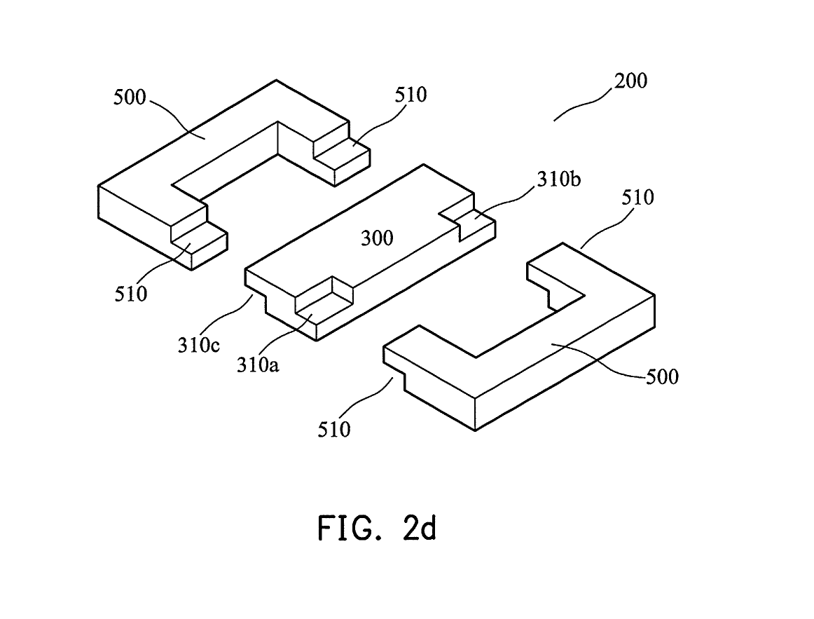

Refer to FIG. 2(a) illustrating the exploded view of the transformer 200 according to the first embodiment of the present invention. In the first embodiment, the core structure 200 further includes an I-core 300 and two U-cores 500. Each of the U-cores 500 is coupled to the respective lateral of the I-core 300.

### The Second Embodiment

Refer to FIG. 2(b) illustrating the exploded view of the transformer 200 according to the second embodiment of the present invention. In the second embodiment, the core structure 200 further includes an I-core 300 and two U-cores 500, explained in greater detail below. The I-core 300 includes at least one recessed edge, such as the recessed edge 310a and the recessed edge 310b. The recessed edge 310a and the recessed edge 310b are formed on the terminal of the I-core 300, respectively. It is noteworthy that the recessed edge 310a and the recessed edge 310b are formed on the same surface.

Alternatively, as shown in FIG. 2(c), the I-core 300 includes a plurality of recessed edges, such as the recessed edge 310a, the recessed edge 310b, the recessed edge 310c and the recessed edge 310d. Besides, the recessed edges 310a-d are formed on the four respective corners and the same surface of the I-core 300.

Referring to FIG. 2(b) and FIG. 2(c), the U-cores 500 further includes at least one protrusive edge 510. By means of the protrusive edge 510 and the recessed edges (i.e. the recessed edge 310a and the recessed edge 310b), each of the U-cores 500 is coupled to respective lateral of the I-core 300.

### The Third Embodiment

Refer to FIG. 2(d) illustrating the exploded view of the transformer 200 according to the third embodiment of the present invention. In the third embodiment, the core structure 200 further includes an I-core 300 and two U-cores 500, explained in greater detail below. For example, the I-core 300 includes four recessed edges. However, only three recessed edges, including the recessed edge 3 10a, the recessed edge 310b and the recessed edge 310c, are shown in the figure. The four recessed edges are formed on the corner of the I-core 300. Besides, the four recessed edges are formed on the different surface. Some recessed edges, such as the recessed edge 310a and the recessed edge 310b, are formed on the upper surface of the I-core 300. Other edges, such as the recessed edge 310c, are formed on the lower surface of the I-core 300.

Still refer to FIG. 2(d), the U-cores 500 further includes at least one protrusive edge 510. By means of the protrusive edge 510 and the recessed edges (i.e. the recessed edge 310a and the recessed edge 310b), each of the U-cores 500 is coupled to the respective lateral of the I-core 300. It is noteworthy that in order to match the I-core 300, one U-core 500 has to be placed upside down respective to other U-core 500.

During assembling, the I-core passes through the hollow body of the bobbin such that the two U-cores are coupled to the respective lateral or terminal of the I-core. For example, according to the core structure 200 shown in FIG. 2(b) and FIG. 3, the I-core 300 passes the hollow body of the bobbin 100 and the two U-cores 500 are coupled to the respective lateral or terminal of the I-core 300. In this manner, the protrusive edge 510 of the U-cores 500 are coupled to the recessed edge 310a and the recessed edge 310b and a closed magnetic circuit are provided. After that, the assembly of the present transformer 600 having low profile is completed.

As stated above, the present invention reduces the thickness of the core. Even though the I-core includes recessed edge, the recessed edge does not reduce the entire strength of the I-core since the recessed edge are formed on the respective corers or terminals of the I-core.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A low profile transformer, comprising:
a bobbin; and
a core structure, coupled to said bobbin, said core structure further comprising:
an I-core;
two U-cores, coupled to said I-core.

2. The transformer according to claim 1, wherein said bobbin further comprises a primary coil, a secondary coil and a plurality of pins formed thereon.

3. A low profile transformer, comprising
a bobbin; and
a core structure, coupled to said bobbin, said core structure further comprising:
an I-core, having at least one recessed edge
two U-cores, coupled to said I-core, having at least one protrusive edge;
wherein said U-cores are coupled to said I-core by means of said recessed edge and said protrusive edge.

4. The transformer according to claim 3, wherein said bobbin further comprises a primary coil, a secondary coil and a plurality of pins formed thereon.

5. The transformer according to claim 3, wherein said recessed edge is formed on a terminal of said I-core.

6. The transformer according to claim 3, wherein said protrusive edge is formed on a terminal of said U-core.

7. A low profile transformer, comprising:
a bobbin; and
a core structure, coupled to said bobbin, said core structure further comprising:
an I-core, having at least one recessed edge
two U-cores, coupled to said I-core, having a plurality of protrusive edges
wherein said U-cores are coupled to said I-core by means of said recessed edge and said protrusive edges.

8. The transformer according to claim 7, wherein said bobbin further comprises a primary coil, a secondary coil and a plurality of pins formed thereon.

9. The transformer according to claim 7, wherein said recessed edge is formed on a terminal of said I-core.

10. The transformer according to claim 7, wherein said recessed edges are formed on different surfaces of said U-core.

11. The transformer according to claim 7, wherein said recessed edges are formed on the same surfaces of said U-core.

12.The transformer according to claim 7, wherein said recessed edges are formed on corners of said U-core.
